(19) United States
(12) Patent Application Publication
(10) Pub. No.: US 2008/0125880 A1
(43) Pub. Date: May 29, 2008

(54) METHOD AND APPARATUS FOR AN ADAPTIVE CONTROL SYSTEM

(76) Inventor: Aaron D. Kahn, Arlington, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 11/534,739

(22) Filed: Sep. 25, 2006

Related U.S. Application Data
(63) Continuation-in-part of application No. 11/461,124, filed on Jul. 31, 2006.

(51) Int. Cl. G05B 13/04

(52) U.S. Cl. 700/30

(57) ABSTRACT

Apparatus includes a reference model unit operable to generating a reference model state signal and a reference model state acceleration signal, the reference model state signal being based, at least in part, on a command control signal. The apparatus includes a reference model limiter including a minimum reference model acceleration value and a maximum reference model acceleration value, and bounding the reference model state acceleration signal be the minimum reference model acceleration value and the maximum reference model acceleration value. Optionally, the apparatus further includes a pseudo-control hedge unit including the reference model limiter and outputting a hedge signal to the reference model unit.

### CROSS-REFERENCE TO RELATED APPLICATION

This application is a continuation-in-part application of, and claims priority to, U.S. patent application Ser. No. 11/461,124, entitled “METHOD AND APPARATUS FOR AN ADAPTIVE CONTROL SYSTEM,” to Kahn.

### TECHNICAL FIELD

The invention is directed to an adaptive control system and related method. More particularly, the invention is directed to an adaptive control system that reduces undesired adaptation of a control system due to selected characteristic(s) of the plant or control system.

### DESCRIPTION OF RELATED ART

Pseudo-control hedge theory is described, by way of example, in U.S. Pat. No. 6,618,631, incorporated herein by reference in its entirety; Eric N. Johnson and Suresh K. Kannan, “Adaptive Flight Control for an Autonomous Unmanned Helicopter, ” AIAA 2002-4439, AIAA Guidance, Control, and Navigation Conference, 2002, incorporated herein be reference in its entirety; Suresh K. Kannan and Eric N. Johnson, “Adaptive Trajectory Based Control for Autonomous Helicopters, ” Digital Avionics and Systems Conference, 2002, incorporated herein by reference in its entirety; and Eric N. Johnson, Limited Authority Adaptive Flight Control, Doctoral Thesis, Department of Aerospace Engineering, Georgia Institute of Technology, 2000, incorporated herein by reference in its entirety.

The pseudo-control hedge theory, as stated in these references, was developed to prevent an adaptive controller from adapting to undesirable dynamics. In the most basic form, these undesirable dynamics and take the form as actuator position and/or rate saturation. Given a controller architecture as seen in FIG. 1, the pseudo-control hedge works as follows.

First, a reference model, Q(xᵣₘ, \dot{x}ᵣₘ, x_{c}) is used to generate a smooth trajectory, v_{crm} based on the command x_{c} as seem in Equation 1.

v_{crm}=Q(xᵣₘ, \dot{x}ᵣₘ, x_{c}) (1)

A proportional-derivative compensator is then used to drive the error between the reference model states and plant states to zero as in Equation 2.

v_{pd}=Kₚ(xᵣₘ−x)+K_{D}(\dot{x}ᵣₘ−\dot{x}) (2)

A neural network in conjunction with an adaptation law is used to generate the signal, vad, to cancel model error present in the approximate dynamic inverse. The three signals, V_{crm}, v_{pd}, v_{ad} are summed together as such.

v=v_{crm}+v_{pd}−v_{ad} (3)

The final result of Equation 3 is the total pseudo-control. This signal is then fed into a dynamic inverse of the form

δ_{cmd}=f⁻¹(v, x, \dot{x}) (4)

where δ_{crm} is the desired actuator commands. This signal is then passed to the actuators on the plant. Due to the dynamics of the actuators in the plant, the resulting signal, δ is what the plant receives.

The pseudo-control hedge works by first taking an estimate of δ, of the from \hat{δ}. This estimate is then used with the forward path of the dynamic inverse such that

\hat{v}=f(x, \dot{x}, \hat{δ}) (5)

where f is the approximate model of the plant. The signal, vₕ, which is the pseudo-control hedge is then generated by

vₕ=v−\hat{v}

vₖ=v−f(x, \dot{x}, \hat{δ}) (6)

The hedge signal is then used to “move” the reference model by the amount that the plant did not move. This is done as such

\ddot{x}ᵣₘ=v_{crm}−vₕ (7)

The result of this hedging of the reference model is the effect that the actuator dynamics are hidden from the neural network. If this was not done then the network would “see” these dynamics as modeling errors in the approximate dynamic inverse. This is undesired, as these effects have the potential to cause the network adaptation to become unstable.

It is assumed in the developed of this work that all internal dynamics are propagated in continuous time, or at a sufficiently high rate that one can approximate the propagation as continuous. A sufficiently high rate is, for example, at least four times the Nyquest frequency of the reference model and/or the plant dynamics. This assumption limits application of such prior art adaptive controllers to computers which have sufficient CPU computational power to execute the controller mechanics such that the above continuous time assumption if valid.

### SUMMARY OF THE INVENTION

An embodiment of the invention includes an apparatus, including a reference model unit operable to generating a reference model state signal and a reference model state acceleration signal, the reference model state signal being based, at least in part, on a command control signal. The apparatus includes a reference model limiter including a minimum reference model acceleration value and a maximum reference model acceleration value, and bounding the reference model state acceleration signal by the minimum reference model acceleration value and the maximum reference model acceleration value.

Optionally, the apparatus further includes a pseudo-control hedge unit including the reference model limiter and outputting a hedge signal to the reference model unit.

Optionally, the apparatus further includes a first adder operable to receive the reference model state signal and generating a summed signal. The apparatus further includes a proportional-derivative compensator operable to output a proportional-derivative signal to the first adder. The apparatus further includes a neural network operable to output an adaptive dynamic inversion model correction signal to the first adder. Optionally, the apparatus further includes a pseudo-control hedge unit the reference model limiter, receiving the summed signal, and outputting a hedge signal to the reference model unit; includes an approximate dynamic inverse unit operable to receive the summed signal and outputting an actuator command signal; and includes a plant actuator operable to receive the actuator command signal and outputting a plant command signal. Optionally, the apparatus further includes a plant operable to receive the plant command signal from the plant actuator; a second adder operable to communicate with the plant, the reference model unit, and the proportional derivative compensator; and an adaptation law unit operable to communicate with the neural network and the second adder, wherein the plant outputs at least one of a plant state signal and a plant state velocity signal to the second adder, to the pseudo-control hedge unit, to the approximate dynamic inverse unit, and to the neural network; wherein the reference model unit outputs the reference model state signal and a reference model state velocity signal to the second adder, and wherein the second adder outputs a reference model error signal to the adaptation low unit and to the proportional-derivative compensator.

Optionally, the apparatus further includes a pseudo-control hedge unit operable to output a hedge signal to the reference model unit, the pseudo-control hedge unit including a hedge signal limiter, which includes a minimum hedge signal value and a maximum hedge signal value and which bounds the hedge signal within the minimum hedge signal value and the maximum hedge signal value.

Another embodiment of the invention includes an apparatus including a reference model unit operable to generate a reference model state signal based, at least in part, on a command control signal; and a pseudo-control hedge unit operable to output a hedge signal to the reference model unit, the pseudo-control hedge unit including a hedge signal limiter, which includes a minimum hedge signal value and a maximum hedge signal value and which bounds the hedge signal by the minimum hedge signal value and the maximum hedge signal value. Optionally, the apparatus further includes a reference model limiter including a minimum reference model acceleration signal and a maximum reference model acceleration signal, and bounding the reference model state acceleration signal by the minimum reference model acceleration signal and the maximum reference model acceleration signal. Optionally, the pseudo-control hedge unit comprises the reference model limiter and outputting a hedge signal to the reference model unit. Optionally, the apparatus further includes a first adder operable to receive said reference model state signal and generating a summed signal; a proportional-derivative compensator operable to output a proportional-derivative signal to the first adder; and a neural network operable to output an adaptive dynamic inversion model correction signal to the first adder. Optionally, the apparatus further includes a pseudo-control hedge unit including the reference model limiter, receiving the summed signal, and outputting a hedge signal to the reference model unit; an approximate dynamic inverse unit operable to receive the summed signal and outputting an actuator command signal; and a plant actuator operable to receive the actuator command signal and outputting a plant command signal. Optionally, the apparatus further includes a plant operable to receive the plant command signal from the plant actuator; a second adder operable to communicate with the plant, the reference model unit, and the proportional derivative compensator; and an adaptation law unit operable to communicate with the neural network and the second adder, wherein the plant outputs at least one of a plant state signal and a plant state velocity signal to the second adder, to the pseudo-control hedge unit, to the approximate dynamic inverse unit, and to the neural network; wherein the reference model unit outputs the reference model state signal and a reference model state velocity signal to the second adder, and wherein the second adder outputs a reference model error signal to the adaptation law unit and to the proportional-derivative compensator.

Another embodiment of the invention includes a method. A reference model state signal is generated based, at least in part, on a command control signal. A reference model state acceleration signal is generated based on the reference model state signal. The reference model state acceleration signal is generated based on the reference model state signal. The reference model state acceleration signal is bounded by a minimum reference model acceleration value and a maximum reference model acceleration value. Optionally, the method further includes generating a summed signal based, at least in part, on the reference model state signal, a proportional-derivative signal, and an adaptive dynamic inversion model correction signal; and generating a hedge signal based, at least in part, on the summed signal; generating an actuator command signal based, at least in part, on the summed signal; and generating a plant command signal based, at least in part, on the actuator command signal. Optionally, the method further includes generating at least one of a plant state signal and a plant state velocity signal. Optionally, the method further includes generating a hedge signal; and bounding the hedge signal by a minimum hedge signal value and by a maximum hedge signal value, wherein the reference model state signal is based, at least in part, on the hedge signal.

An advantage of an embodiment of the invention is the ability to implement an adaptive controller on more computing platforms than has been possible using prior art controllers. In such an embodiment, no longer is the controller limited to being run at a high rate, such that the assumption of continuous time is maintained. An embodiment of the invention guarantees that the reference model states will remain bounded during periods when vₕ is large, which is of vital importance for the overall stability of the control system.

An embodiment of the invention thus helps to further provide additional margins of safety if this controller is implemented in any number of vehicle control applications.

### BRIEF DESCRIPTION OF THE DRAWINGS

FIG. 1 is a prior art adaptive controller architecture with pseudo-control hedging.

FIG. 2 is an illustrative block diagram of the instant invention.

FIG. 3 is an illustrative flow chart of an illustrative method according to the instant invention.

FIG. 4 is an illustrative aspect of the controller's reference model architecture according to an embodiment of the instant invention.

FIG. 5 is an illustrative aspect of the controller's reference model architecture according to another embodiment of the instant invention.

### BEST MODE FOR CARRYING OUT THE INVENTION

In the development of pseudo-control hedges as applied to the reference model unit, it has been assumed that all internal dynamics are propagated in continuous time, or at a sufficiently high rate that one can approximate the propagation as continuous. However, I recognized that a problem can occur in Equation (7), if this assumption is violated, such as the case if one implements this control theory with larger time steps in a digital computer.

More specifically, the problem occurs when the controller is propagated at relatively low rate when compared to the bandwidth of the reference model dynamics. If one assumes that the pseudo-control hedge signal is always zero, then the reference model can be integrated in time with no problem, so long as the integration time step is four times the Nyquist frequency of the reference model dynamics. Under this requirement, the reference model propagation is valid so long as all the reference model dynamics are smooth. But, I discovered that this smoothness requirement can be violated if under certain conditions, the instantaneous pseudo-control hedge becomes large. The pseudo-control hedge signal then causes an instantaneous jump in the acceleration signal to the reference model through Equation (7). If

$$‖ {\ddot{x}}_{rm} ‖ > \frac{{ζω}_{n}}{2} \overline{V} \qquad ( 8 )$$

then there is no guarantee that the reference model dynamics can continue to be propagated forward in time successfully. In Equation (8), ζ is the reference model damping ratio, ωₙ is the reference model natural frequency, and V̅ is the maximum velocity that the reference model can attain.

The invention solves the above problem of using the pseudo-control hedging, as described in Equations (6) and (7), by enforcing the requirement that the dynamics of the reference model must be within a set of known bounds. These bounds are known beforehand as the update rate of the controller is limited by these dynamics. Using the rule in Equation (8), a limiter can be designed into the reference model block as such.

$${\overline{\ddot{x}}}_{rn} = \frac{{ζω}_{u}}{2} \overline{V} \\ {\ddot{x}}_{rm} = [ \begin{matrix}{\overline{\ddot{x}}}_{rm} , {v}_{crm} - {v}_{h} > {\overline{\ddot{x}}}_{rm} \\ {v}_{crm} - {v}_{h} \\ - {\overline{\ddot{x}}}_{rm} , {v}_{crm} - {v}_{h} < - {\overline{\ddot{x}}}_{rm}\end{matrix} ] \qquad ( 9 )$$

### If the vₕ signal becomes large, then ∥v_{crm}∥ is always less-than or equal to

$${\overline{\ddot{x}}}_{rn} , \qquad$$

which is the maximum acceleration value that the reference model can ever achieve.

This new invention, as described in Equation (9), replaces what is done in Equation (7) of the reference model block. With this limiting in place, the reference model dynamics are now fully guaranteed to remain stable regardless of the magnitude of vₕ. The functionality of the pseudo-control hedging block is still maintained as this acceleration saturation will quickly be passed as the reference model is moved by the hedge.

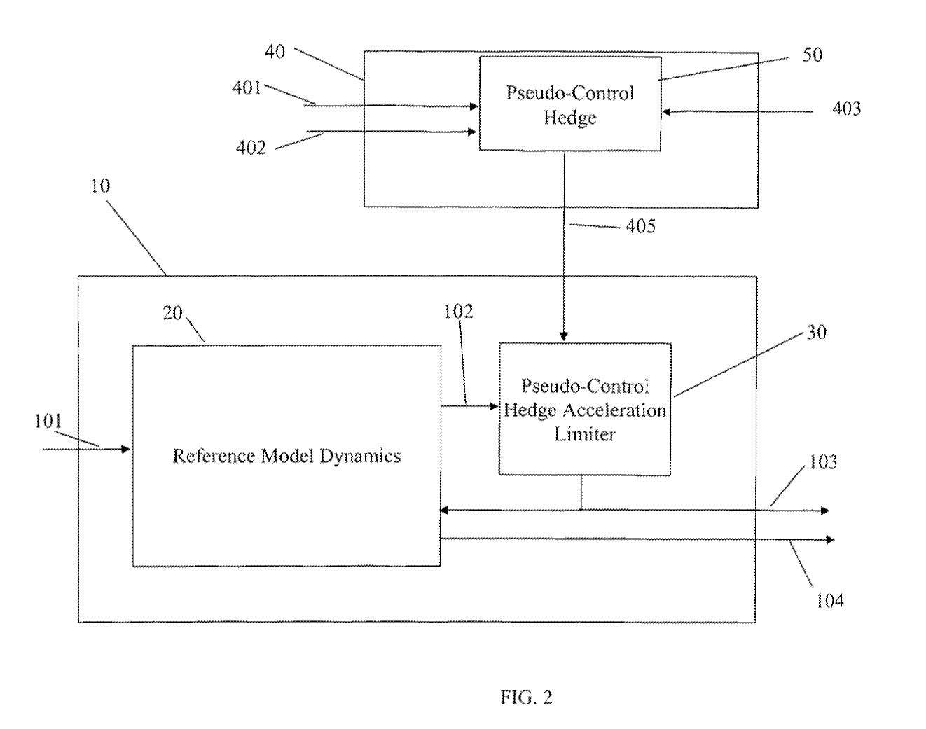

An embodiment of an apparatus according to the instant invention is shown in FIG. 2. The reference model unit 10 includes a reference model dynamics unit 20 operable to generating a reference model state signal 104, and a reference model state acceleration signal 102. The reference model state signal is based, at least in part, on a command control signal, 101. The apparatus also includes a pseudo-control hedge acceleration limiter 30 including a minimum reference model acceleration value and a maximum reference model acceleration value, and bounding the reference model state acceleration signal 102, by the minimum reference model acceleration value and the maximum reference model acceleration value, resulting in bounded reference model state acceleration signal 103.

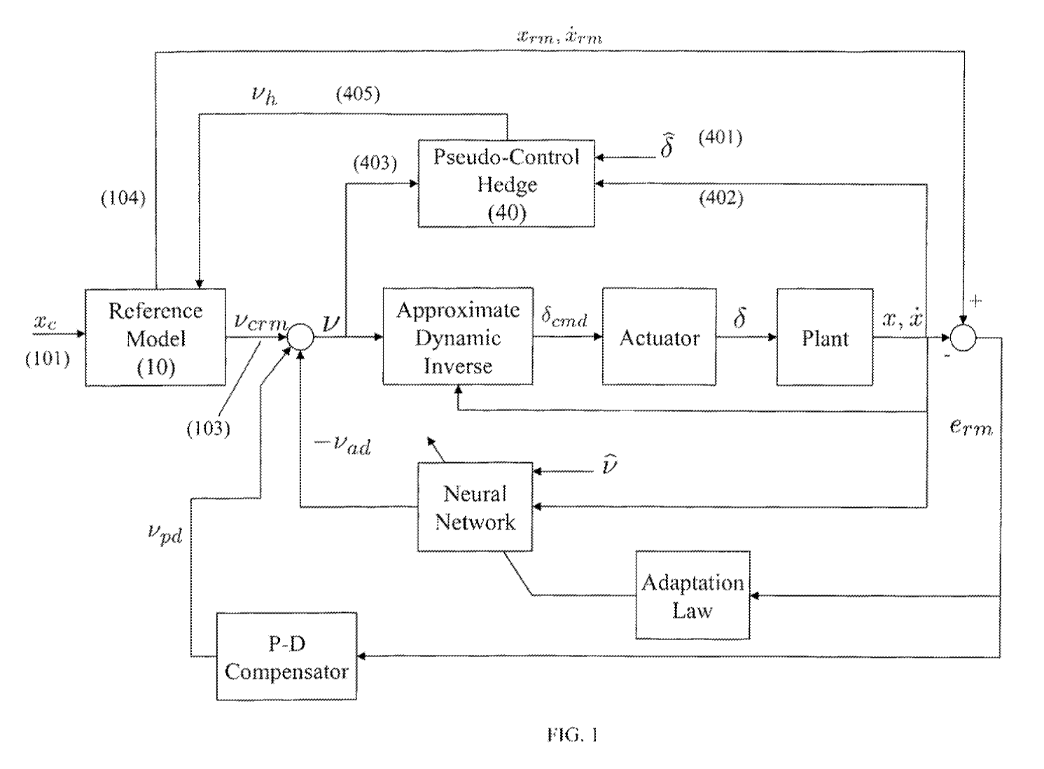

The apparatus optionally includes a pseudo-control hedge unit 40 comprising said pseudo-control hedge generator unit 50. Optional pseudo-control hedge generator unit 50 is driven by signals 401, 402, and 403 (as seen in FIG. 1). Pseudo-control hedge signal 405 is fed to pseudo-control hedge acceleration limiter unit 30.

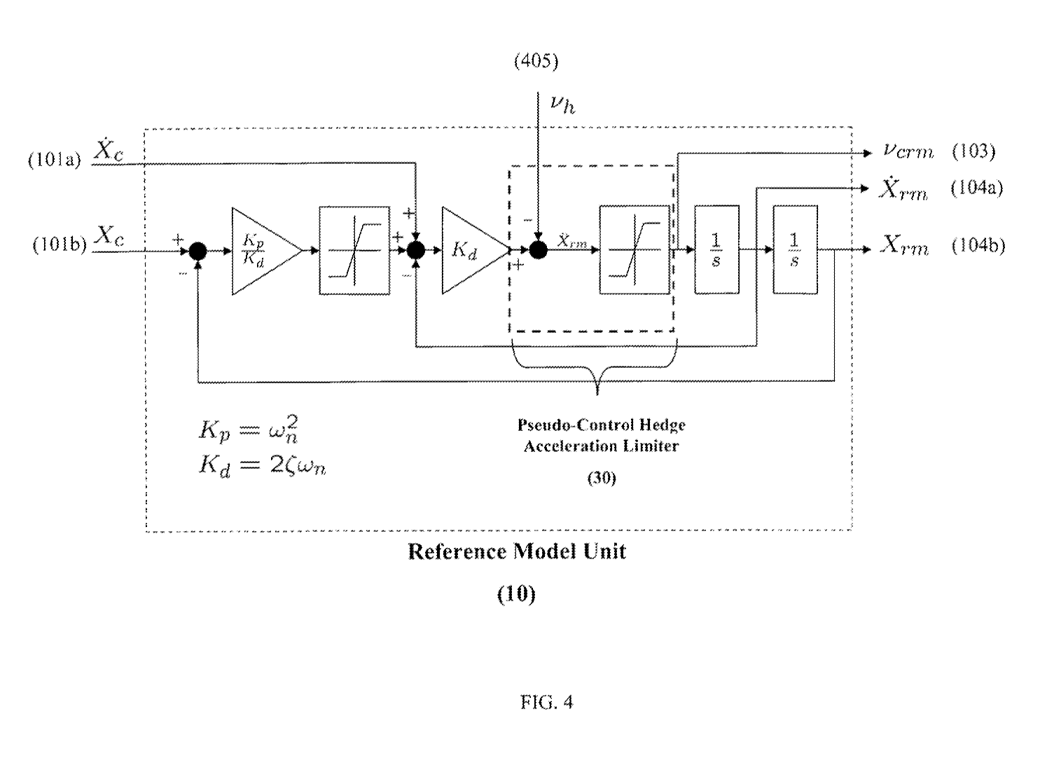

A detailed diagram of the reference model unit 10, including the reference model dynamics unit 20 which includes velocity limiting, and the pseudo-control acceleration limiter unit 30 are shown in FIG. 4. Pseudo-control hedge acceleration limiter is shown in FIG. 4 as block 30.

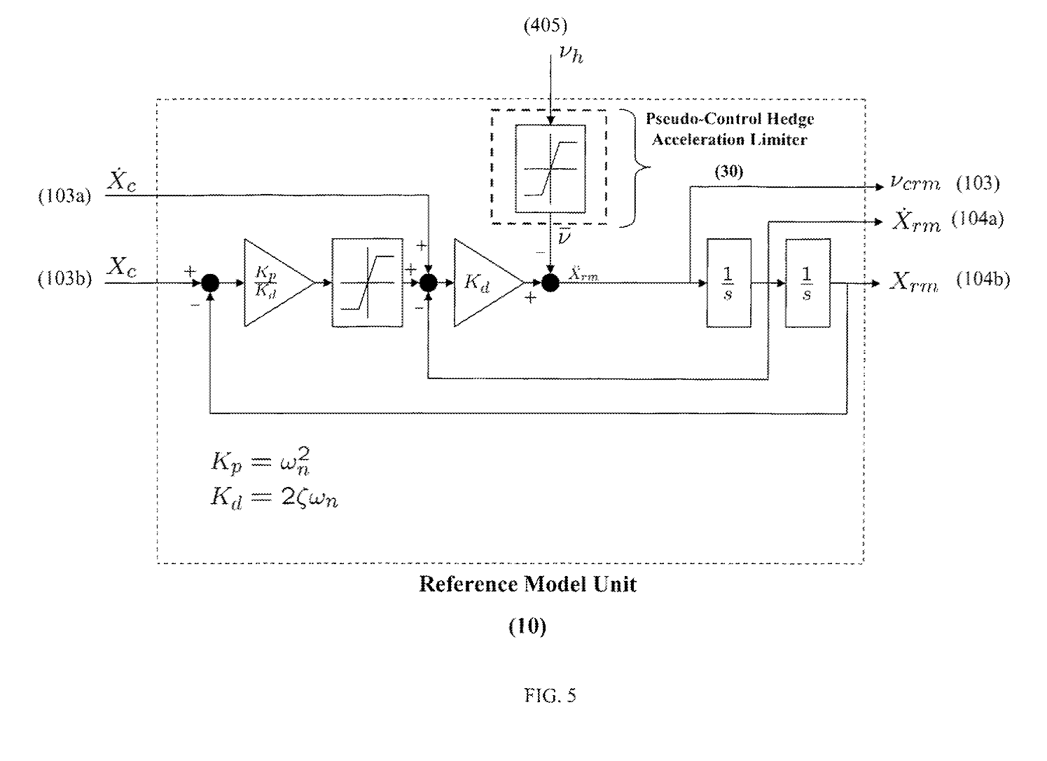

Another embodiment of a pseudo-control hedge acceleration limiter according to the instant invention is shown in FIG. 5, as block (30). The reference model dynamics unit 20 shown also includes velocity limiting.

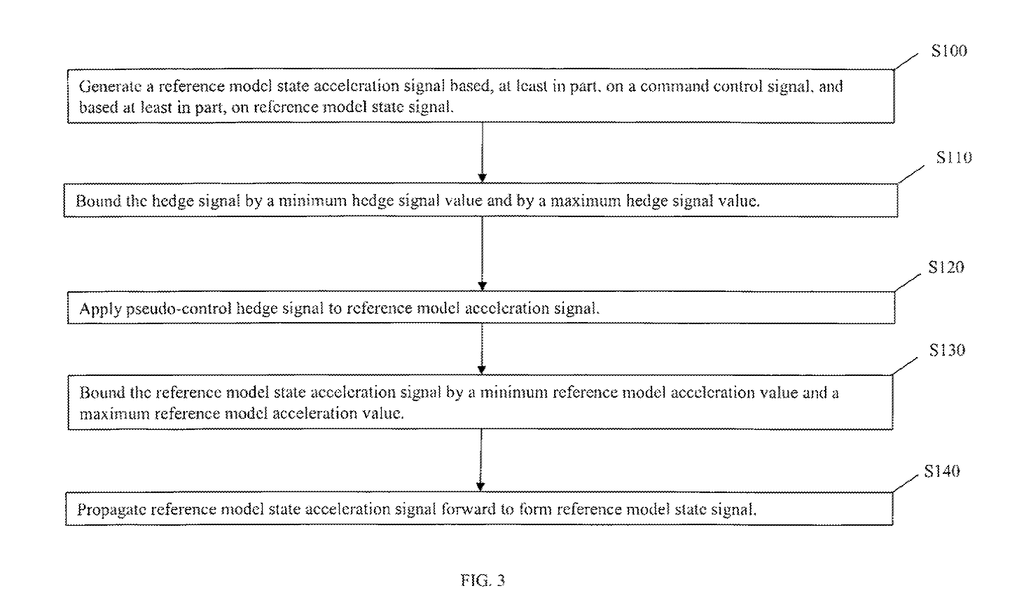

An advantage of an embodiment of the invention, such as the one shown in FIG. 3, is the ability to implement an adaptive controller on more computing platforms than has been possible using prior art controllers. Examples of such computing platforms include low-cost microcontrollers and low-power microprocessors.

In an alternative embodiment, the instant invention, as seen in Equation 9, is limiting the maximum magnitude of the pseudo-control hedge acceleration signal. The reason this limiting is needed is because of the unknown and unpredictable magnitude of the pseudo-control hedge signal. One could apply the following limit as such

$${v}_{h} = [ \begin{matrix}\overline{v} , v - \hat{v} > \overline{v} \\ v - \hat{v} \\ - \overline{v} , v - \hat{v} < - \overline{v}\end{matrix} ] \qquad ( 10 )$$

where v̅ is the maximum value that the pseudo-control hedge signal can take on, and \hat{v} is defined in Equation 5. The result of Equation 10 could then be used in Equation 7 to generate the reference model acceleration. This method and apparatus cannot guarantee that the reference model states will remain bounded. It is not to say that the value for v̅ could not be calculated in real-time, but this method would soon decompose into Equation 9. This alternative approach is shown in FIG. 5 with modified reference model unit 10 and the limiter as block 30.

A target plant for the implementation of an adaptive controller is any plant that contains dynamics that are difficult to estimate a priori, and thus requires the use of on-line adaptation to account for uncertainty in the dynamic modeling of the plant. Examples of such plants include aerial vehicles, such as helicopters and airplanes, which have complicated aerodynamic, structural, and actuation dynamics that are difficult to model completely during controllers synthesis.

The adaptive element within the controller is, for example, implemented as a single hidden layer perceptron neural-network. Other adaptive elements, such as a bank of single integrators, are alternatively used.

An embodiment of a method according to the instant invention is shown in FIG. 3. In step S100, a reference model state signal is generated based, at least in part, on a command control signal and current reference model state signal. In optional Step S110, the pseudo-control hedge signal is bounded between a maximum pseudo-control hedge value and minimum pseudo-control hedge value. In Step S120, the pseudo-control hedge value (bounded or not) is applied to the reference model state acceleration signal. In Step S130, the modified reference model state acceleration signal is bounded between a maximum acceleration value and minimum acceleration value. In Step S140, the reference model state acceleration signal is used to propagate forward in time the reference model state signal.

Obviously, many modifications and variations of the instant invention are possible in light of the above teachings. It is therefore to be understood that the scope of the invention should be determined by referring to the following appended claims.

What is claimed is:

1. An apparatus comprising:
a reference model unit operable to generating a reference model state signal and a reference model state acceleration signal, said reference model state signal being based, at least in part, on a command control signal;
a reference model limiter including a minimum reference model acceleration value and a maximum reference model acceleration value, and bounding the reference model state acceleration signal by the minimum reference model acceleration value and the maximum reference model acceleration value.

2. The apparatus according to claim 1, further comprising:
a pseudo-control hedge unit comprising said reference model limiter and outputting a hedge signal to said reference model unit.

3. The apparatus according to claim 1, further comprising:
a first adder operable to receive said reference model state signal and generating a summed signal;
a proportional-derivative compensator operable to output a proportional-derivative signal to said first adder; and
a neural network operable to output an adaptive dynamic inversion model correction signal to said first adder.

4. The apparatus according to claim 3, further comprising:
a pseudo-control hedge unit comprising said reference model limiter, receiving the summed signal, and outputting a hedge signal to said reference model unit;
an approximate dynamic inverse unit operable to receive the summed signal and outputting an actuator command signal; and
a plant actuator operable to receive the actuator command signal and outputting a plant command signal.

5. The apparatus according to claim 4, further comprising:
a plant operable to receive the plant command signal from said plant actuator;
a second adder operable to communicate with said plant, said reference model unit, and said proportional derivative compensator; and
an adaptation law unit operable to communicate with said neural network and said second adder,
wherein said plant outputs at least one of a plant state signal and a plant state velocity signal to said second adder, to said pseudo-control hedge unit, to said approximate dynamic inverse unit, and to said neural network;
wherein said reference model unit outputs the reference model state signal and a reference model state velocity signal to said second adder, and
wherein said second adder outputs a reference model error signal to said adaptation law unit and to said proportional-derivative compensator.

6. The apparatus according to claim 1, further comprising:
a pseudo-control hedge unit operable to output a hedge signal to said reference model unit, said pseudo-control hedge unit including a hedge signal limiter, which includes a minimum hedge signal value and a maximum hedge signal value and which bounds the hedge signal within the minimum hedge signal value and the maximum hedge signal value.

7. An apparatus comprising:
a reference model unit operable to generate a reference model state signal based, at least in part, on a command control signal; and
a pseudo-control hedge unit operable to output a hedge signal to said reference model unit, said pseudo-control hedge unit including a hedge signal limiter, which includes a minimum hedge signal value and a maximum hedge signal value and which bounds the hedge signal by the minimum hedge signal value and the maximum hedge signal value.

8. The apparatus according to claim 7, further comprising:
a reference model limiter including a minimum reference model acceleration signal and a maximum reference model acceleration signal, and operable to bound the reference model state acceleration signal by the minimum reference model acceleration signal and the maximum reference model acceleration signal.

9. The apparatus according to claim 8, wherein said pseudo-control hedge unit comprises said reference model limiter and operable to output a hedge signal to said reference model unit.

10. The apparatus according to claim 8, further comprising:
a first adder operable to receive said reference model state signal and generating a summed signal;
a proportional-derivative compensator operable to output a proportional-derivative signal to said first adder; and
a neural network operable to output an adaptive dynamic inversion model correction signal to said first adder.

11. The apparatus according to claim 10, further comprising:
a pseudo-control hedge unit comprising said reference model limiter, operable to receive the summed signal, and operable to output a hedge signal to said reference model unit;
an approximate dynamic inverse unit operable to receive the summed signal and outputting an actuator command signal; and
a plant actuator operable to receive the actuator command signal and operable to output a plant command signal.

12. The apparatus according to claim 11, further comprising:
a plant operable to receive the plant command signal from said plant actuator;
a second adder operable to communicate with said plant, said reference model unit, and said proportional derivative compensator; and
an adaptation law unit operable to communicate with said neural network and said second adder,
wherein said plant is operable to output at least one of a plant state signal and a plant state velocity signal to said second adder, to said pseudo-control hedge unit, to said approximate dynamic inverse unit, and to said neural network;
wherein said reference model unit is operable to output the reference model state signal and a reference model state velocity signal to said second adder, and
wherein said second adder is operable to output a reference model error signal to said adaptation law unit and to said proportional-derivative compensator.

13. A method comprising:
generating a reference model state signal based, at least in part, on a command control signal;
generating a reference model state acceleration signal based on the reference model state signal; and
bounding the reference model state acceleration signal by a minimum reference model acceleration value and a maximum reference model acceleration value.

14. The method according to claim 13, further comprising:
generating a summed signal based, at least in part, on the reference model state signal, a proportional-derivative signal, and an adaptive dynamic inversion model correction signal; and
generating a hedge signal based, at least in part, on the summed signal;
generating an actuator command signal based, at least in part, on the summed signal; and
generating a plant command signal based, at least in part, on the actuator command signal.

15. The method according to claim 14, further comprising:
generating at least one of a plant state signal and a plant state velocity signal.

16. The method according to claim 13, further comprising:
generating a hedge signal; and
bounding the hedge signal be a minimum hedge signal value and by a maximum hedge signal value,
wherein the reference model state signal is based, at least in part, on the hedge signal.
